(19) United States
(12) Patent Application Publication
(10) Pub. No.: US 2014/0089236 A1
(43) Pub. Date: Mar. 27, 2014

(54) LEARNING METHOD USING EXTRACTED DATA FEATURE AND APPARATUS THEREOF

(71) Applicant: ELECTRONICS AND TELECOMMUNICATIONS RESEARCH INSTITUTE, Daejeon (KR)

(72) Inventors: Yong Jin LEE, Daejeon (KR); So Hee PARK, Daejeon (KR); Jong Gook KO, Daejeon (KR); Ki Young MOON, Daejeon (KR); Jang Hee YOO, Daejeon (KR)

(73) Assignee: Electronics and Telecommunications Research Institute, Daejeon (KR)

(21) Appl. No.: 13/733,407

(22) Filed: Jan. 3, 2013

(30) Foreign Application Priority Data
Sep. 25, 2012 (KR) 10-2012-0106685

(51) Int. Cl. G06N 99/00

(52) U.S. Cl. CPC G06N 99/005
USPC 706/12

(57) ABSTRACT

Disclosed is a learning method using extracted data features for simplifying a learning process or improving accuracy of estimation. The learning method includes dividing input learning data into two groups based on a predetermined reference, extracting data features for distinguishing the two divided groups, and performing learning using the extracted data features.

### CLAIM FOR PRIORITY

This application claims priority to Korean Patent Application No. 10-2012-0106685 filed on Sep. 25, 2012 in the Korean Intellectual Property Office (KIPO), the entire contents of which are hereby incorporated by reference.

### BACKGROUND

1. Technical Field

Example embodiments of the present invention relate in general to a learning method and a learning apparatus and more specifically to a learning method using extracted data features that may provide high recognition performance and a learning apparatus thereof.

2. Related Art

From the point of view of pattern recognition or machine learning, sex recognition may be seen as a problem of binary classification of distinguishing between men and women.

On the other hand, age recognition may be seen as a problem of multi-classification of distinguishing among pre-teens, the teens, and those in their twenties, thirties, forties, fifties, sixties, and seventies or more, or a problem of regression of estimating the age in detail in units of one year such as an 11-year-old or a 23-year-old. In addition, pose recognition of recognizing vertical and horizontal directions of a user's face based on face image data of the user may be also seen as a problem of multi-classification or regression.

Pose classification of approximating an angle of the user's face into −80 degrees, −60 degrees, −40 degrees, −20 degrees, 0 degrees, +20 degrees, +40 degrees, +60 degrees, and +80 degrees depending on vertical and horizontal directions of the user's face to thereby estimate may be also seen as a problem of multi-classification. On the other hand, a case of subdividing the angle of the user's face into continuous values such as +11 degrees or −23 degrees to thereby estimate may be seen as a problem of regression.

A regression analyzer or a classifier is configured in the form of a function in which an input value and an output value are connected. A process of connecting the input value and the output value of the function using data prepared in advance may be referred to as learning (or training), and data for the learning may be referred to a learning (training) data.

The learning data is configured of input values and target values (or desirable outputs) with respect to the input values. For example, in the case of the age recognition or pose recognition using the face image information, the face image information corresponds to the input values, and ages or poses (face orientation angle) of corresponding face image information correspond to the target values.

The learning process is performed by adjusting parameters of a function constituting the regression analyzer or classifier, and is performed by adjusting parameter values or obtaining optimized parameter values so that output values and target values of a function with respect to input values coincide as much as possible.

Meanwhile, in order to simplify the learning process or improve accuracy of estimation, a feature extraction process has been introduced, and studies on the feature extraction process have been continuously made.

### SUMMARY

Accordingly, example embodiments of the present invention are provided to substantially obviate one or more problems due to limitations and disadvantages of the related art.

Example embodiments of the present invention provide a learning method using extracted data features in order to simplify a learning process or improve accuracy of estimation.

Example embodiments of the present invention also provide a learning apparatus using extracted data features in order to simplify a learning process or improve accuracy of estimation.

In some example embodiments, a learning method using extracted data features, which is performed in a learning device, includes: dividing input learning data into two groups based on a predetermined reference; extracting data features for distinguishing the two divided groups; and performing learning using the extracted data features.

Here, after the extracting, when there is a group required to be divided into sub-groups among the two groups, the learning method may further include dividing the group required to be divided into the sub-groups; and extracting data features for distinguishing the divided sub-groups.

Here, the extracting of the data features for distinguishing the two divided groups may include setting one group of the two divided groups as a class 1 and setting the other group thereof as a class 2, acquiring a variance between the class 1 and the class 2 and a projection vector for enabling a ratio of the variance between the class 1 and the class 2 to be a maximum value, and extracting the data features by projecting the input learning data to the acquired projection vector.

Here, the extracting of the data features for distinguishing the two divided groups may include extracting candidate features for the input learning data, assigning a weight to individual data included in the input learning data, selecting a part of the individual data in accordance with the weight assigned to the individual data, learning classifiers for classifying the two groups using the part of the individual data with respect to each of the candidate features, calculating accuracy of the classifiers based on the input learning data and the weight assigned to the individual data, selecting the classifier having the highest accuracy as the classifier having the highest classification performance, and extracting the candidate features used in learning the classifier having the highest classification performance as the data features for distinguishing the two groups.

Here, the extracting of the data features for distinguishing the two divided groups may further include reducing the weight of the individual data classified by the classifier having the highest classification performance, and increasing the weight of the individual data excluding the classified individual data, determining whether the data features for distinguishing the two groups are output by the number of the data features set in advance, and repeatedly performing the process from the selecting of the part of the individual data to the determining until the data features for distinguishing the two groups are extracted by the number of the data features set in advance when the data features are determined not to be extracted by the number of the data features set in advance.

Here, in the selecting of the part of the individual data, a probability of selecting the higher weight assigned to the individual data may be high.

Here, the extracting of the data features for distinguishing the two divided groups may include extracting the data features for distinguishing the two divided groups through at least one of an image filter, a texture expression method, wavelet analysis, a Fourier transform, a dimension reduction method, and a feature extraction means.

Here, after the performing of the learning, the learning method may further include inputting face image data to a result of the performing of the learning to thereby extract an age or a pose corresponding to the face image data.

In other example embodiments, a learning apparatus using extracted data features, includes: a learning data providing unit that provides input learning data; a feature extraction unit that divides the learning data into two groups based on a predetermined reference, and extracts data features for distinguishing the two divided groups to thereby provide the extracted data features; and a processing unit that performs learning using the extracted data features.

Here, when there is a group required to be divided into sub-groups among the two groups, the feature extraction unit may divide the group required to be divided into the sub-groups, and extract data features for distinguishing the divided sub-groups to thereby provide the extracted data features to the processing unit.

Here, the feature extraction unit may set one group of the two divided groups as a class 1 and sets the other group thereof as a class 2, acquire a variance between the class 1 and the class 2 and a projection vector for enabling a ratio of the variance between the class 1 and the class 2 to be a maximum value, and then extract the data features by projecting the input learning data to the acquired projection vector.

Here, the feature extraction unit may extract the data features for distinguishing the two divided groups through at least one of an image filter, a texture expression method, wavelet analysis, a Fourier transform, a dimension reduction method, and a feature extraction means.

Here, when face image data is provided from the learning data providing unit, the processing unit may input the face image data to a result obtained by performing the learning to thereby extract an age or a pose corresponding to the face image data.

### BRIEF DESCRIPTION OF DRAWINGS

Example embodiments of the present invention will become more apparent by describing in detail example embodiments of the present invention with reference to the accompanying drawings, in which:

FIG. 1 is a flowchart showing a learning process using extracted data features according to an embodiment of the present invention;

FIG. 2 is a conceptual diagram showing a feature extraction method;

FIG. 3 is a conceptual diagram showing a feature extraction method through an age recognition process;

FIG. 4 is a conceptual diagram showing a feature extraction method through a pose recognition process;

FIG. 5 is a conceptual diagram showing data feature extraction of a learning method using extracted data features according to an embodiment of the present invention;

FIG. 6 is a flowchart showing a process of extracting data features of a learning method using extracted data features according to an embodiment of the present invention;

FIG. 7 is a face image showing data feature extraction of a learning process using extracted data features according to an embodiment of the present invention;

FIG. 8 is a conceptual diagram showing a filter set used for data feature extraction of a to learning process using extracted data features according to an embodiment of the present invention;

FIG. 9 is a conceptual diagram showing a face image filtered for illustrating a candidate feature extraction method of a learning process using extracted data features according to an embodiment of the present invention;

FIG. 10 is a conceptual diagram showing a case in which only a value of a specific region of each filtered face image of a learning process using extracted data features according to an embodiment of the present invention is used;

FIG. 11 is a block diagram showing a configuration of a learning apparatus using extracted data features according to an embodiment of the present invention;

FIG. 12 is a conceptual diagram showing a method of configuring a classifier for determination for each of ages according to an embodiment of the present invention;

FIG. 13 is a conceptual diagram showing a method of selecting learning data in which separation of an age or a pose is ambiguous;

FIG. 14 is a drawing showing probability distribution and a posteriori probability with respect to one dimensional features x for illustrating a method of selecting learning data whose separation is ambiguous; and

FIG. 15 is a drawing showing probability distribution and a posteriori probability for each group with respect to a classification result depending on the one dimensional features x of FIG. 14.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise” It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

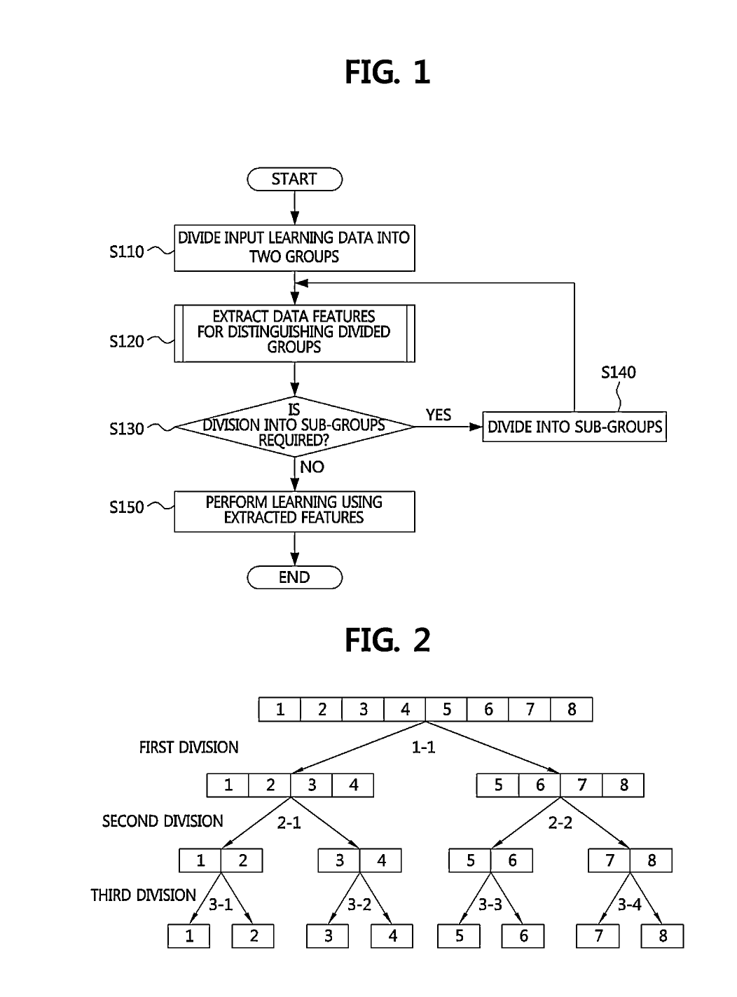

FIG. 1 is a flowchart showing a learning process using extracted data features according to an embodiment of the present invention.

Hereinafter, it is assumed that learning data is composed of a plurality of unit data, and individual data is composed of a pair of input data and a target value. For example, face image data in age recognition and pose (face orientation angle) recognition using face image information corresponds to the input data, and the age or the pose corresponds to the target value.

Referring to FIG. 1, in step S110, a learning apparatus using extracted data features (hereinafter referred to as a “learning apparatus”) according to an embodiment of the present invention receives learning data, and divides the input learning data into two groups based on a target value.

In step S120, the learning apparatus selects or extracts data features for readily distinguishing the two groups divided in step S110.

Next, in step S130, the learning apparatus determines whether the two divided groups are required to be divided into sub-groups.

In step S140, the learning apparatus divides the two groups into the sub-groups when it is determined through step S130 that the two divided groups are required to be divided into the sub-groups, and repeatedly performs step S120.

Alternatively, in step S150, the learning apparatus performs learning using the data features extracted in step S120 when it is determined in step S130 that the two divided groups are not required to be divided into the sub-groups.

Here, the learning apparatus may not be required to use all of the extracted data features, and may use data features which are selectively extracted in accordance with a configuration of the learning apparatus.

A case in which the learning apparatus using the extracted data features according to an embodiment of the present invention divides the two divided groups in half based on a target value has been described, but according to another embodiment of the present invention, the divided groups need not have the same number of sub-groups.

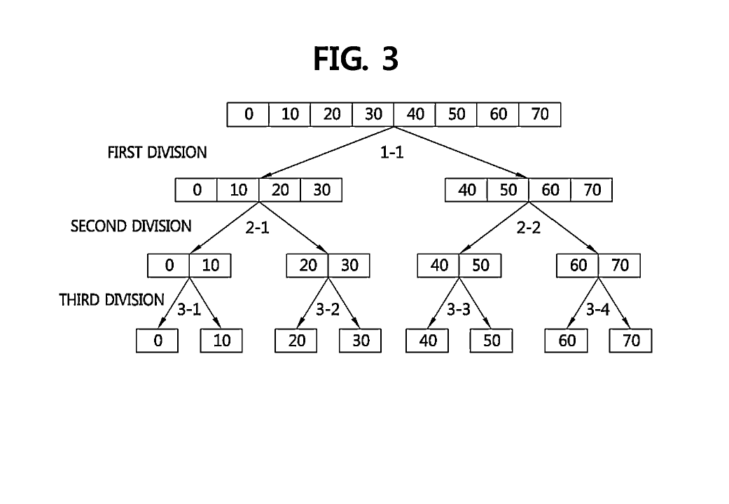

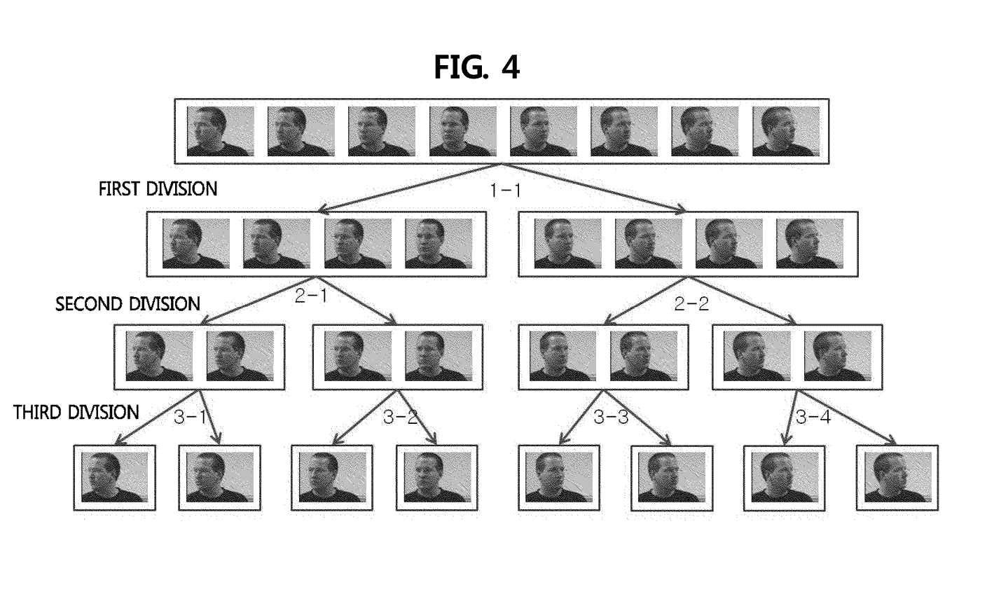

FIG. 2 is a conceptual diagram showing a feature extraction method, FIG. 3 is a conceptual diagram showing a feature extraction method through an age recognition process, and FIG. 4 is a conceptual diagram showing a feature extraction method through a pose recognition process.

Referring to FIGS. 2 to 4, in FIG. 2, numbers 1 to 8 indicate target values of learning data or values obtained by grouping the learning data based on the target values.

Specifically, the learning apparatus divides (1-1) the entire learning data group [1, 2, 3, 4, 5, 6, 7, 8] into a group [1, 2, 3, 4] and a group [5, 6, 7, 8] through first division, and selects or extracts features for readily distinguishing input data included in the group [1, 2, 3, 4] and input data included in the group [5, 6, 7, 8].

In addition, the learning apparatus respectively divides the group [1, 2, 3, 4] and the group [5, 6, 7, 8] into two groups through second division. That is, the learning apparatus divides (2-1) the group [1, 2, 3, 4] into a group [1, 2] and a group [3, 4], and divides (2-2) the group [5, 6, 7, 8] into a group [5, 6] and a group [7, 8].

Next, the learning apparatus selects or extracts features for readily distinguishing input data included in the group [1, 2] and input data included in the group [3, 4]. In addition, the learning apparatus selects or extracts features for readily distinguishing input data included in the group [5, 6] and input data included in the group [7, 8].

In addition, the learning apparatus divides (3-1) the group [1, 2] into a group [1] and a group [2] through third division, and selects or extracts features for readily distinguishing input data included in the group [1] and input data included in the group [2].

By repeatedly performing the above-described process, the learning apparatus respectively divides (3-2) the group [3, 4] into a group [3] and a group [4], divides (3-3) the group [5, 6] into a group [5] and a group [6], and divides (3-4) the group [7, 8] into a group [7] and a group [8], and extracts or selects features for readily distinguishing the divided groups.

The above-described first to third divisions are performed by dividing in half with respect to the target values for the convenience of description, and the divided groups need not have the same number of sub-groups.

Referring to FIG. 3, 0, 10, 20, 30, 40, 50, 60, and 70 respectively indicate pre-teens, teens, and those in their twenties, thirties, forties, fifties, sixties, and seventies, and respectively correspond the groups [1], [2], [3], [4], [5], [6], [7], and [8] of FIG. 2.

In FIG. 3, for the convenience of description, age data is divided in units of decades, but the present invention is not limited thereto. That is, the age data need not be equally divided.

First, the learning apparatus divides (1-1) the entire learning data group [0, 10, 20, 30, 40, 50, 60, 70] into a group [0, 10, 20, 30] and a group [40, 50, 60, 70] through the first division, and selects or extracts features for readily distinguishing face image data included in the group [0, 10, 20, 30] and face image data included in the group [40, 50, 60, 70].

In addition, the learning apparatus respectively divides the group [0, 10, 20, 30] and the group [40, 50, 60, 70] into two groups through second division. That is, the learning apparatus divides (2-1) the group [0, 10, 20, 30] into a group [0, 10] and a group [20, 30], and divides (2-2) the group [40, 50, 60, 70] into a group [40, 50] and a group [60, 70].

Next, the learning apparatus selects or extracts features for readily distinguishing face image data included in the group [0, 10] and face image data included in the group [20, 30]. In addition, the learning apparatus selects or extracts features for readily distinguishing the group [40, 50] and the group [60, 70].

In addition, the learning apparatus divides (3-1) the group [0, 10] into a group [0] and a group [10], and selects or extracts features for readily distinguishing face image data included in the group [0] and face image data included in the group [10].

By repeatedly performing the same process, the learning apparatus divides (3-2) the group [20, 30] into a group [20] and a group [30], divides (3-4) the group [40, 50] into a group [40] and a group [50], and extracts or selects features for readily distinguishing the divided groups.

In addition, the learning apparatus may repeatedly perform the above-described process while dividing a corresponding group into sub-groups, as necessary.

Referring to FIG. 4, a pose of each face corresponds to groups [1], [2], [3], [4], [5], [6], [7], and [8] of FIG. 2 or groups [0], [10], [20], [30], [40], [50], [60], and [70] of FIG. 3.

As described through FIGS. 2 and 3, the learning apparatus repeatedly divides the learning data based on a face orientation angle in a stepwise manner to thereby divide the learning data into two groups, and then selects or extracts features for readily classifying the face image data respectively divided into two groups. Next, the selected or extracted features may be used for detailed pose estimation or pose classification.

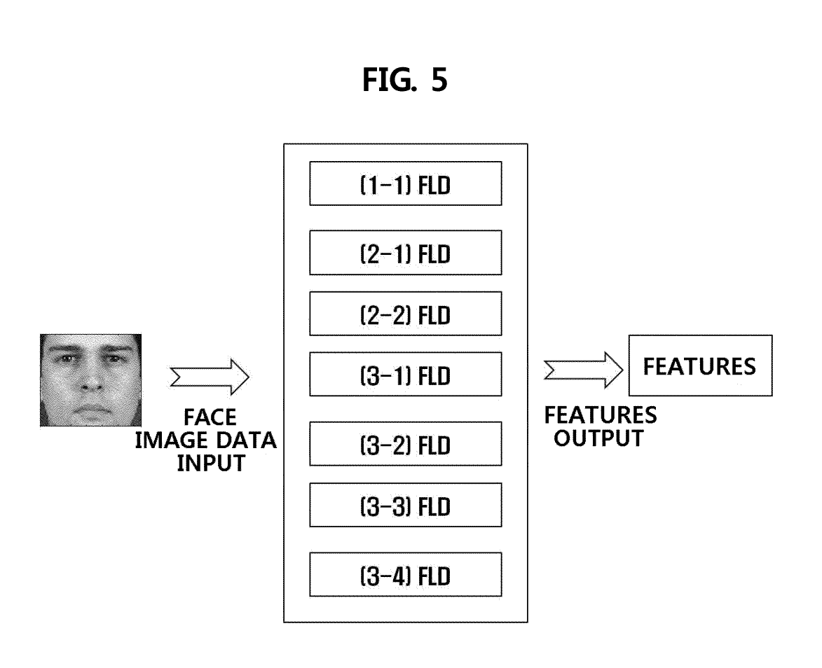

FIG. 5 is a conceptual diagram showing data feature extraction of a learning method using extracted data features according to an embodiment of the present invention.

The extracting or selecting of the data features which has been described through FIGS. 1 to 4 may be performed through an image filter (for example, a primary Gaussian differential filter, a secondary Gaussian differential filter, a Gaussian filter, a Laplacian filter, a Gabor filter, a Sobel filter, or the like), a texture expression method (for example, modified census transform (MCT) and local binary transform (LBT)), wavelet analysis, a Fourier transform, an image process such as a dimension reduction method (for example, principal component analysis (PCA), locality preserving projection (LPP), margin preserving projection (MPP), Fisher linear discriminant (FLD)) or the like, a feature extraction means and method or algorithm.

Alternatively, the extracting or selecting of the data features may be performed through optimized setting values or an application combination of the image process, the feature extraction means and method or algorithm, and the like.

Hereinafter, a method of extracting features according to an embodiment of the present invention using FLD that is the dimension reduction method will be described.

The FLD obtains a projection vector w for enabling a ratio (Equation 1) of between-class covariance and within-class covariance to be a maximum.

Next, data features are extracted by projecting data to the obtained projection vector w.

$$J ( w ) = \frac{{w}^{T} {S}_{B} w}{{w}^{T} {S}_{w} w} \qquad [ Equation 1 ]$$

Here, a between-class covariance S_{B} and a within-class covariance S_{W} are respectively denoted as Equation 2 and Equation 3.

$$\begin{matrix} {S}_{B} = ( {m}_{2} - {m}_{1} ) {( {m}_{2} - {m}_{1} )}^{T} & [ Equation 2 ] \\ {S}_{w} = {\sum }_{n ∈ {C}_{1}}^{ } ( {x}_{n} - {m}_{1} ) {( {x}_{n} - {m}_{1} )}^{T} + {\sum }_{n ∈ {C}_{2}}^{ } ( {x}_{n} - {m}_{2} ) {( {x}_{n} - {m}_{2} )}^{T} & [ Equation 3 ]\end{matrix}$$

In Equations 2 and 3, m₁ and m₂ respectively denote an average of input data included in a class 1 and a class 2, C₁ denotes an index set of data included in the class 1, and C₂ denotes an index set of data included in the class 2. In Addition, xₙ denotes input data of learning data.

In FIGS. 2 to 4, one of the groups divided into two is set as the class 1, and the other thereof is set as the class 2, and the projection vector which is effective for dividing the two groups is calculated by applying the FLD.

The calculated projection vector w is used to perform a regression or multi-classification method.

For example, in the case of age recognition of FIG. 3, the learning apparatus sets the group [0, 10, 20, 30] of the first division as a class 1 and the group [40, 50, 60, 70] of the first division as a class 2, and calculates a projection vector w which is effective for distinguishing the group [0, 10, 20, 30] and the group [40, 50, 60, 70] using Equation 1.

In addition, the learning apparatus sets the group [0, 10] of the second division as a class 1 and the group [20, 30] of the second division as a class 2, and calculates a projection vector w which is effective for distinguishing the group [0, 10] and the group [20, 30]. In addition, the learning apparatus sets another group [40, 50] of the second division as a class 1 and another group [60,70] of the second division as a class 2 in the same manner, and calculates a projection vector w which is effective for distinguishing the group [40,50] and the group [60,70].

In addition, the learning apparatus sets the group [0] of third division as a class 1 and the group [10] of third division as a class 2, and calculates a projection vector w which is effective for distinguishing the group [0] and the group [10]. In addition, the learning apparatus repeatedly performs the above-described process with respect to the remaining groups of the third division.

When the settings are performed as shown in FIG. 3, a total of seven projection vectors ([1-1]FLD, [2-1]FLD, [2-2]FLD, [3-1]FLD, [3-2]FLD, [3-3]FLD, [3-4]FLD) are generated by applying the above-described process.

Referring to FIG. 5, the learning apparatus may input face image data to the total of seven projection vectors generated by applying the above-described process, and perform regression or multi-classification using the extracted features.

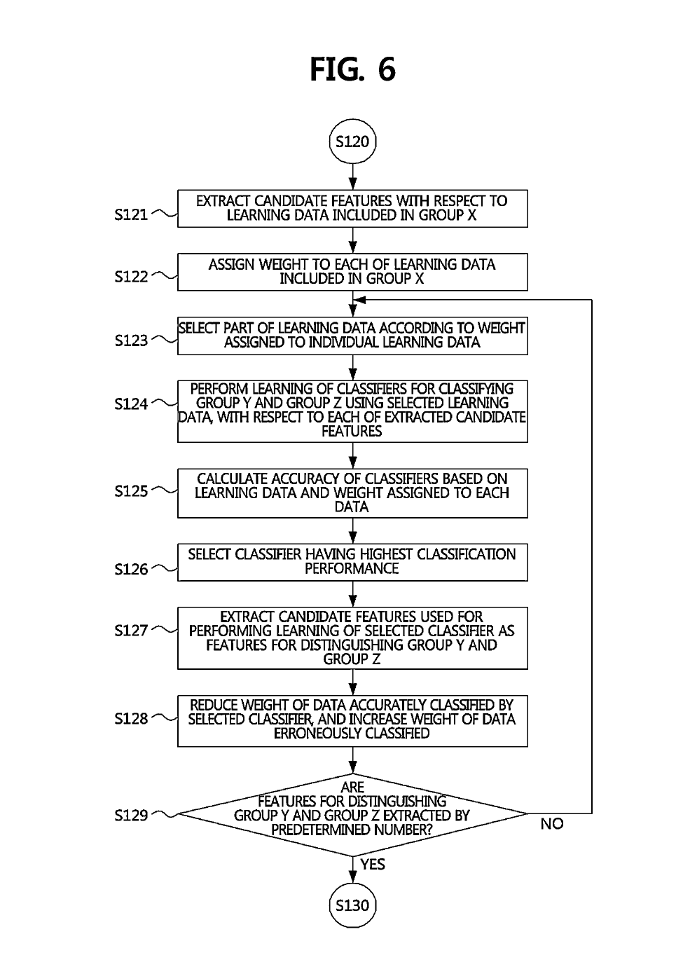

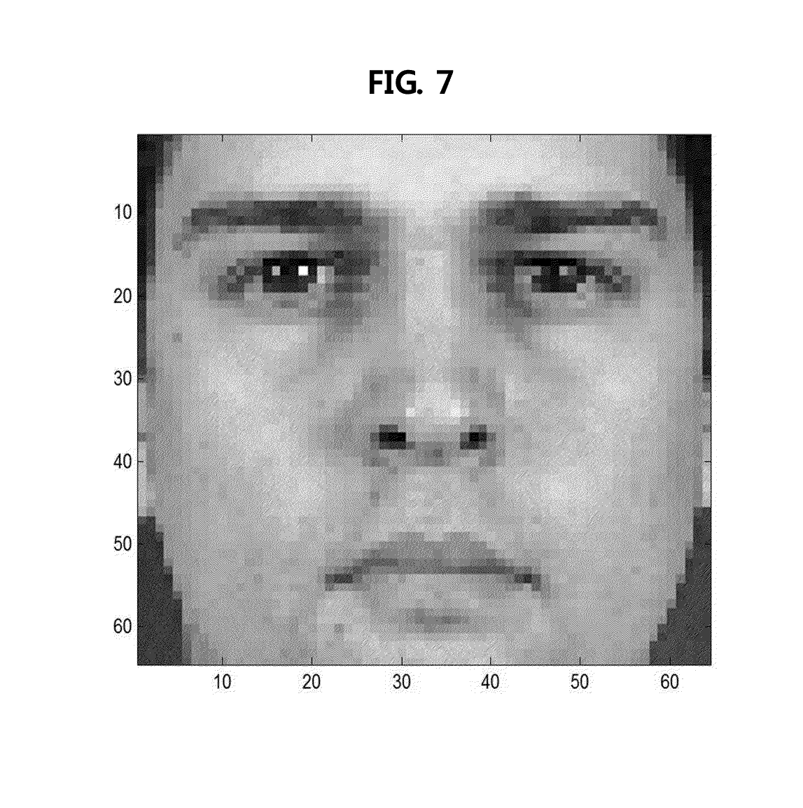

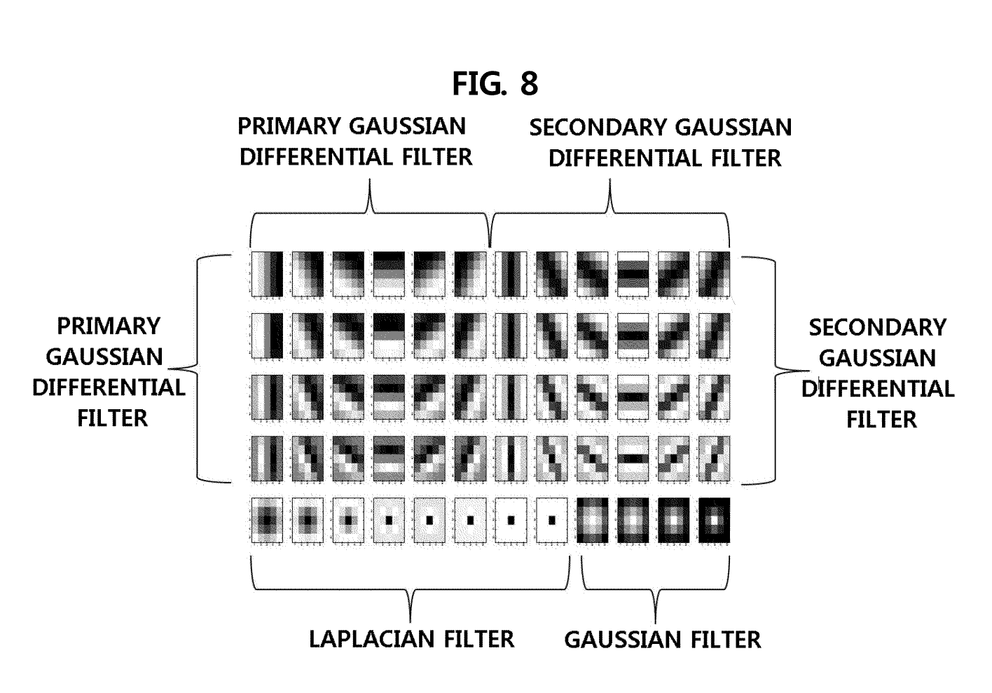

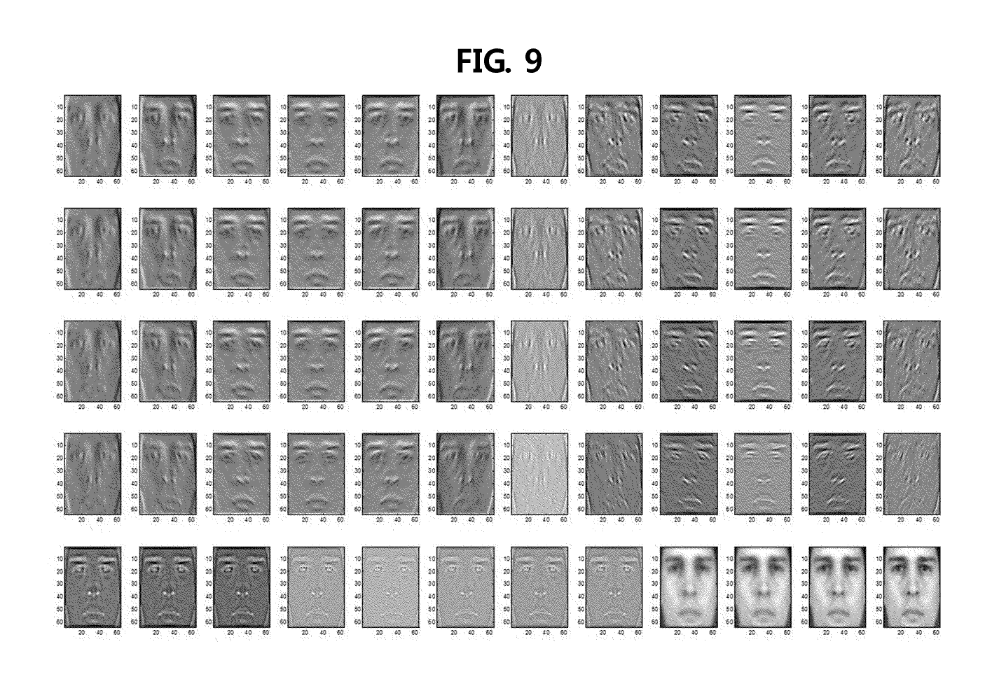

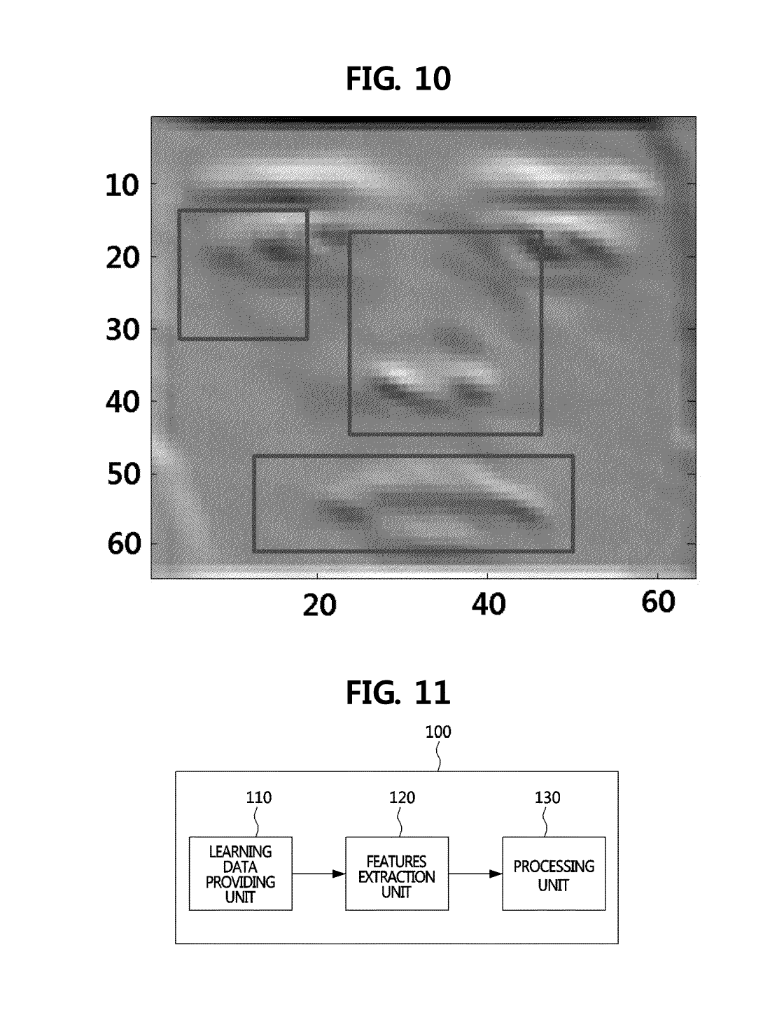

FIG. 6 is a flowchart showing a process of extracting data features of a learning method using extracted data features according to an embodiment of the present invention, FIG. 7 is a face image showing data feature extraction of a learning process using extracted data features according to an embodiment of the present invention, FIG. 8 is a conceptual diagram showing a filter set used for data feature extraction of a learning process using extracted data features according to an embodiment of the present invention, FIG. 9 is a conceptual diagram showing a face image filtered for illustrating a candidate feature extraction method of a learning process using extracted data features according to an embodiment of the present invention, and FIG. 10 is a conceptual diagram showing a case in which only a value of a specific region of each filtered face image of a learning process using extracted data features according to an embodiment of the present invention is used.

Referring to FIGS. 6 to 10, as described through FIG. 2 (or FIGS. 3 and 4), it is assumed that learning data is repeatedly performed based on a target value (for example, age or pose) in a stepwise manner to thereby be divided, and an upper data group is X and lower data groups are Y and Z.

Hereinafter, a method of extracting features for effectively distinguishing a group X and a group Z using Adaboost will be described.

Referring to FIG. 6, in step S121, the learning apparatus extracts candidate features for learning data included in the group X.

For example, when applying an image processing filter set shown in FIG. 8 to an original face image shown in FIG. 7, a result of FIG. 9 may be obtained.

Here, the image processing filter set may be composed of 24 primary Gaussian differential filters, 24 secondary Gaussian differential filters, 8 Laplacian filters, and 4 Gaussian filters.

In addition, each of filtered images of FIG. 9 may be features with respect to a face image of FIG. 7.

In addition, as shown in FIG. 10, only a value of a specific region within each of the filtered images may be used. That is, the large number of features may be generated through a variety of setting combinations.

The features of the extracted image in the learning method using features of the extracted image according to an embodiment of the present invention may be defined or specified as a type of a filter or a position or shape of the region. Hereinafter, for the convenience of description, the number of the entire candidate features is D, and a process of selecting the features will be described.

Referring again to FIG. 6, in step S122, the learning apparatus assigns a weight to each of learning data included in the group X.

In step S123, the learning apparatus selects a part of the learning data in accordance with the weight assigned to individual learning data.

Here, a probability of selecting the higher weight assigned to the individual learning data may be high.

In step S124, the learning apparatus learns classifiers for classifying the group Y and the group Z using learning data selected through step S123, with respect to each of the candidate features extracted through step S121.

Here, D classifiers may be generated through step S124.

In step S125, the learning apparatus calculates accuracy of the classifiers based on the learning data included in the group X and the weight assigned to each data.

In step S126, the learning apparatus selects a classifier having the highest accuracy through step S125 as a classifier having the highest classification performance.

In step S127, the learning apparatus extracts the candidate features used in learning the classifier selected thorough step S126, as features for distinguishing the group Y and the group Z.

Next, in step S128, the learning apparatus reduces a weight of data accurately classified by the selected classifier, and increases a weight of data erroneously classified.

In step S129, the learning apparatus determines whether the features for distinguishing the group Y and the group Z are extracted by a predetermined number of features.

When it is determined that the features are not extracted by the predetermined number of features, the learning apparatus returns to step S123, and repeatedly performs a procedure until the features for distinguishing the group Y and the group Z are extracted by the predetermined number of features.

FIG. 11 is a block diagram showing a configuration of a learning apparatus using extracted data features according to an embodiment of the present invention.

Referring to FIG. 11, a learning apparatus 100 using extracted data features according to an embodiment of the present invention may include a learning data providing unit 110, a feature extraction unit 120, and a processing unit 130.

First, the learning data providing unit 110 receives an image, and provides the input image to the feature extraction unit 120.

The feature extraction unit 120 divides the image input from the learning data providing unit 110 into two groups.

In addition, the feature extraction unit 120 selects or extracts data features for readily distinguishing the two divided groups.

In addition, the feature extraction unit 120 determines whether the two divided groups are required to be divided into sub-groups, divides each of the two groups into sub-groups when it is determined that the two divided groups are required to be divided into sub-groups, and selects or extracts data features for distinguishing the group divided into the sub-groups.

Alternatively, when it is determined that the two divided groups are not required to be divided into sub-groups, the feature extraction unit 120 provides the data features selected or extracted so far to the processing unit 130.

The processing unit 130 performs learning using the data features provided from the feature extraction unit 120.

Here, the processing unit 130 may perform regression that may estimate detailed ages using the provided data features or a classification method that may classify ages.

In addition, the processing unit 130 does not need to all of the data features provided from the feature extraction unit 120, and may use the data features selectively provided in accordance with a configuration of the learning apparatus 100.

According to the learning apparatus using the extracted data features according to an embodiment of the present invention, a learning process may be simplified, and accuracy of estimation may be improved.

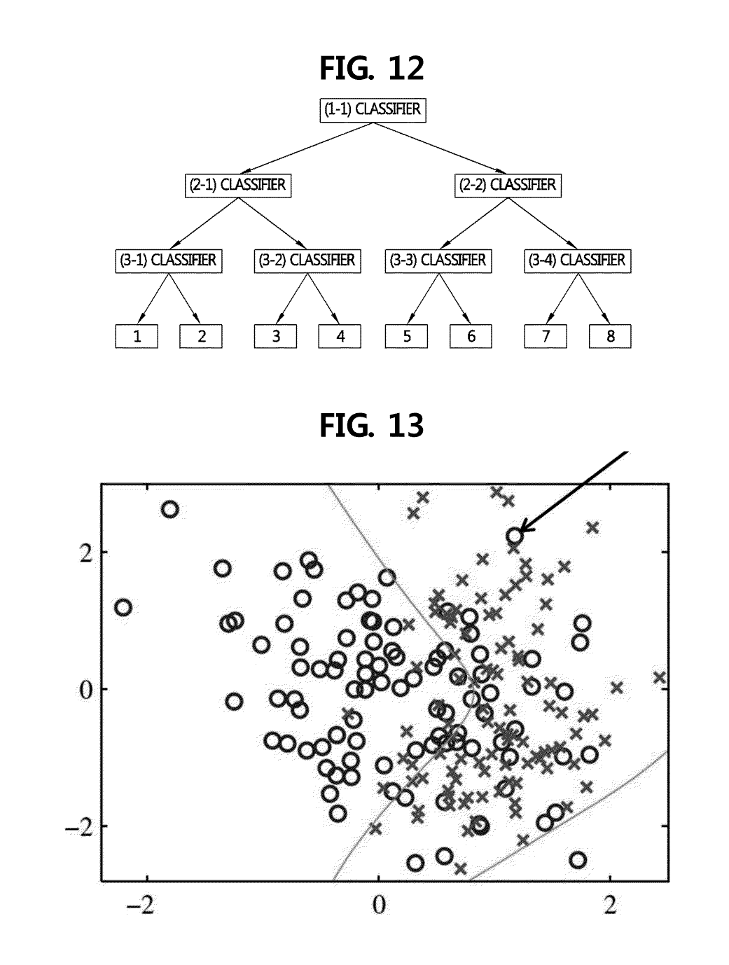

FIG. 12 is a conceptual diagram showing a method of configuring a classifier for determination for each of ages according to an embodiment of the present invention.

Using the data features which have been extracted or selected through the above-described data feature extraction or selection, a learning and configuration method of a multi-classifier will be described. Here, the classifier is not limited to a specific classifier, and the case of using a binary classifier such as a support vector machine (SVM) will be described.

Referring to FIG. 12, a multi-classifier set may be configured through the following process.

Referring to FIG. 2 (or FIGS. 3 and 4), using extracted (or selected) features so as to readily distinguish the group [1, 2, 3, 4] and the group [5, 6, 7, 8] of the first division of FIG. 1 and the entire learning data, learning of a classifier for classifying into the group [1, 2, 3, 4] and the group [5, 6, 7, 8] is performed (1-1).

In addition, using extracted (or selected) features so as to readily distinguish the group [1, 2] and the group [3, 4] of the second division and learning data included in the group [1, 2, 3, 4], a classifier for readily classifying into the group [1, 2] and the group [3, 4] is learned (2-1).

In addition, using extracted (or selected) features so as to readily distinguish the group [5,6] and the group [7,8] of the second division and learning data included in the group [5, 6, 7, 8], learning of a classifier for classifying into the group [5,6] and the group [7,8] is performed (2-2).

In addition, using extracted (or selected) features so as to readily distinguish the group [1] and the group [2] of the third division and learning data included in the group [1, 2], learning of a classifier for classifying into the group [1] and the group [2] is performed (3-1).

In addition, using extracted (or selected) features so as to readily distinguish the group [3] and the group [4] of the third division and learning data included in the group [3, 4], learning of a classifier for classifying into the group [3] and the group [4] is performed (3-2).

The above-described process may be repeatedly performed with respect to data of the remaining groups.

The multi-classifier configured through the above-described process generates features (for example, the features for distinguishing the group [1, 2, 3, 4] and the group [5, 6, 7, 8]) used in the classifier learning (1-1) from test data when the test data is input, and inputs the generated features into the classifier (1-1).

The classifier (1-1) determines in which group the test data is included among the group [1, 2, 3, 4,] and the group [5, 6, 7, 8].

When it is determined that the test data is included in the group [1, 2, 3, 4], the classifier (1-1) extracts features (for example, the features for distinguishing the group [1, 2] and the group [3, 4]) used in the classifier learning (2-1). In addition, whether the test data is included in the group [1, 2] or the group [3, 4] is determined by inputting the features to the classifier (2-1).

Alternatively, when it is determined that the test data is included in the group [5, 6, 7, 8], the classifier (1-1) extracts features (for example, the features for distinguishing the group [5, 6] and the group [7, 8]) used in the classifier learning (2-2) from the test data. In addition, whether the test data is included in the group [5, 6] or the group [7, 8] is determined by inputting the features to the classifier (2-2).

By applying the above process to a classifier (3-1), a classifier (3-2), a classifier (3-3), and a classifier (3-4) based on the determination results of the classifier (1-1), the classifier (2-1), and the classifier (2-2), finally, a group (for example, ages or pose interval) in which the test data is included may be determined.

The multi-classifier set according to another embodiment of the present invention will be configured through the following process.

Groups are configured one-to-one with each other in pairs, and learning of a classifier for distinguishing the groups constituting the pair is performed.

For example, in FIG. 2 (or FIGS. 3 and 4), learning of a classifier for respectively distinguishing the group [1] and the group [2], the group [1] and the group [3], the group [1] and the group [4], the group [1] and the group [5], the group [1] and the group [6], the group [1] and the group [7], and the group [1] and the group [8] is performed using learning data included in each pair of the groups.

In addition, learning of a classifier for readily distinguishing the group [2] and the group [3], the group [2] and the group [4], the group [2] and the group [5], the group [2] and the group [6], the group [2] and the group [7], and the group [2] and the group [8] is performed.

When the learning is performed in the above-described method, a total of 28(=8×7/2) classifiers may be generated.

When the test data is input to the multi-classifier configured through the above-described process, in which group the input test data is included using the 28 classifiers is determined.

That is, the multi-classifier configured through the above-described process generates 28 determination results with respect to the input test data, and determines a group having the largest number of votes as the group in which the test data is included, by the majority rule.

A multi-classifier set according to still another embodiment of the present invention will be configured through the following process.

Learning of a classifier for forming pairs using one group and the remaining groups for each group, and distinguishing the groups forming the pair is performed.

In FIG. 2 (or FIGS. 3 and 4), learning of a classifier for distinguishing the group [1] and the remaining groups (the group [2], the group [3], the group [4], the group [5], the group [6], the group [7], and the group [8]) is performed using learning data included in each group pair.

In addition, a classifier for distinguishing the group [2] and the remaining groups (the group [1], the group [3], the group [4], the group [5], the group [6], the group [7], and the group [8]) is performed using learning data included in each group pair.

When the learning is performed as described above, a total of 8 classifiers representing each of the group [1], the [2], the group [3], the group [4], the group [5], the group [6], the group [7], and the group [8] are generated.

When the test data is input, the multi-classifier configured through the above-described process generates 8 determination results with respect to the input test data using the generated 8 classifiers.

In addition, the multi-classifier selects a classifier outputting the highest determination value (or the lowest determination value), and determines the ages of test data of a group represented by the selected classifier.

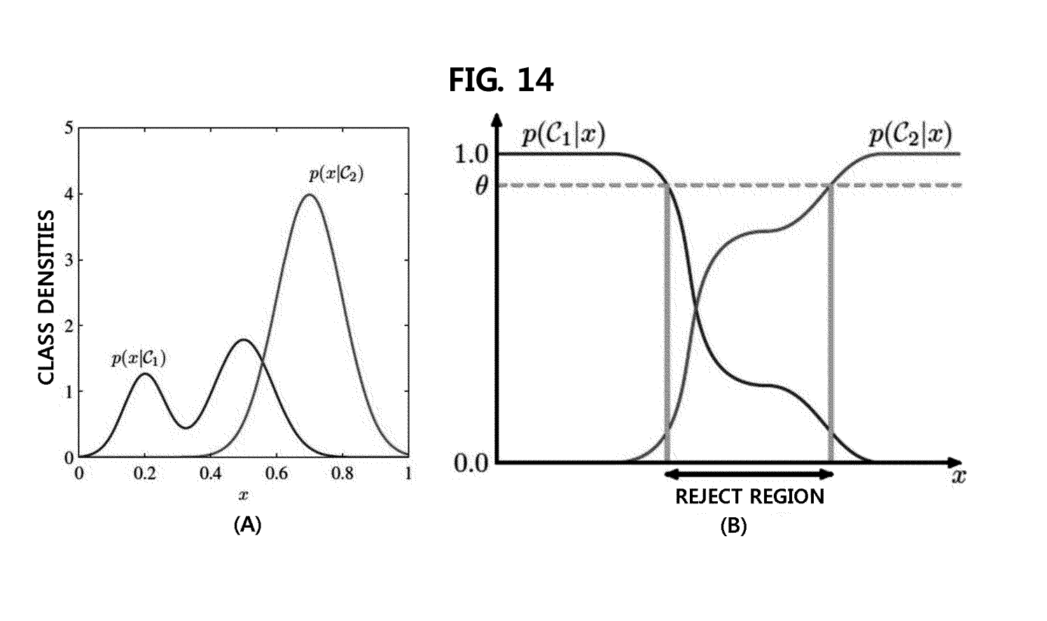

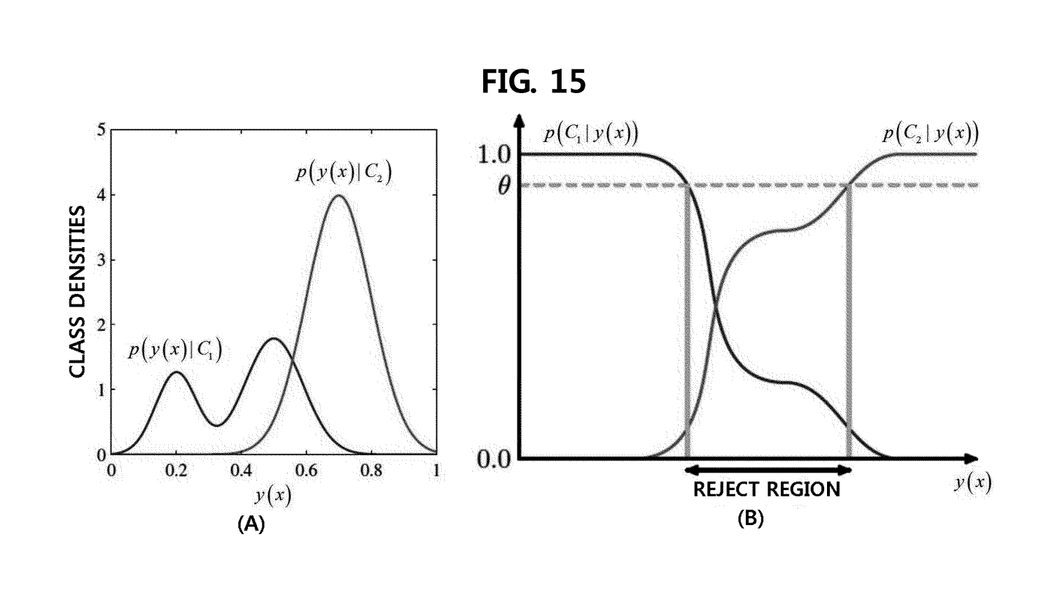

FIG. 13 is a conceptual diagram showing a method of selecting learning data in which separation of an age or a pose is ambiguous, FIG. 14 is a drawing showing probability distribution and a posteriori probability with respect to one dimensional features x for illustrating a method of selecting learning data whose separation is ambiguous, and FIG. 15 is a drawing showing probability distribution and a posteriori probability for each group with respect to a classification result depending on the one dimensional features x of FIG. 14.

A learning and configuration method of a regression analyzer which is used in detailed age or detailed pose estimation using data features extracted or selected through the above-described extraction or selection of the data features will be described.

$$E ( w ) = \frac{1}{2} {\sum }_{n = 1}^{N} {\{ y ( {x}_{n} , a ) - {t}_{n} \}}^{2} \qquad [ Equation 4 ]$$

In Equation 4, N denotes the number of pieces of the entire learning data, a denotes a parameter of a regression function, xₙ denotes n^{th} learning data as an input value of the regression analyzer, and tₙ denotes a target value with respect to n^{th} data.

In the detailed age estimation (or the detailed pose estimation), xₙ corresponds to a face image feature value that is extracted or selected through the above-described method, and tₙ corresponds to a detailed age of the face image data (or detailed pose).

The learning with respect to the regression analyzer is performed by adjusting or calculating a parameter vector a so that a value of Equation 4 is a minimum.

A function of Equation 4 may be denoted as the following Equation 5.

$$y ( {x}_{n} , a ) = {a}_{0} + {\sum }_{j = 1}^{M} {a}_{j} {x}_{n , j} \qquad [ Equation 5 ]$$

Here, M denotes a dimension of a parameter vector a, aⱼ denotes a j^{th} element value of the vector a, and x_{n,j} denotes a j^{th} element value of xₙ.

Data features may be extracted from the face image data input for the age estimation (or pose estimation) using the above-described method, and the age (or pose) with respect to the test data may be calculated when inputting the extracted data features to the regression function.

When features with respect to the test data are x, this process may be represented as the following Equation 6.

$$y ( x ) = {a}_{0} + {\sum }_{j = 1}^{M} {a}_{j} {x}_{j} \qquad [ Equation 6 ]$$

The detailed age estimation and the detailed pose estimation using support vector regression (SVR) as the regression method may be represented as the following Equation 7.

As in the following Equation 7, by calculating a parameter vector a so that a sum of ξₙ and \hat{ξ}ₙ is a minimum while satisfying given restriction conditions, learning of estimating the detailed age or the detailed pose is performed.

$$Min . C {\sum }_{n = 1}^{N} ( {ξ}_{n} + {\hat{ξ}}_{n} ) + \frac{1}{2} {‖ a ‖}^{2} \qquad [ Equation 7 ]$$

subject to.

tₙ≦y(xₙ,a)+ε+ξₙ, for n=1, . . . , N

tₙ≦y(xₙ,a)−ε−ξₙ, for n=1, . . . , N

Here, C denotes a coefficient for reflecting a relative consideration degree of first and second sections of a target function, and ε denotes a coefficient indicating an acceptable error range.

Other than the above-described learning method using the regression analyzer, a learning method using a regression analyzer using a variety of methods such as polynomial Curve Fitting, an artificial neural network and the like may be used.

Hereinafter, a regression analysis method for the detailed age estimation or detailed pose estimation using face information will be described in detail.

In Equation 5 or 7, as described in the learning using the regression analyzer, it is preferable that a difference between an output value of the regression analyzer with respect to an input value and a target value be reduced so that the output value and the target value coincide as much as possible.

However, in a case in which learning data is insufficient, or noise or outline is present in the learning data, when the output value and the target value excessively coincide, recognition performance may be rather reduced due to over-fitting as a whole.

To solve this problem, a similar output value may be obtained with respect to a similar input value while enabling the output value and the target value to coincide with each other.

In particular, the a case of age recognition, accurately estimating an actual age with respect to data of a face image is important, but in an actual application, it is preferable to perform estimation using the age that may be represented as the appearance of a corresponding face image.

Accordingly, when two faces are similar to each other even though the ages of two face images are actually different, it is preferable that learning of the regression analyzer be performed so that similar ages are output.

By reflecting the above, Equation 4 is corrected using Equation 8 so that similar output values are obtained with respect to similar input values while enabling the output value and the target value to coincide.

$$E ( w ) = \frac{C}{2} {\sum }_{n = 1}^{N} {\{ y ( {x}_{n} , a ) - {t}_{n} \}}^{2} + \frac{1}{{N}^{2}} {\sum }_{m = 1}^{N} {\sum }_{n = 1}^{N} {{w}_{m , n} ( y ( {x}_{m} , a ) - y ( {x}_{n} . a ) )}^{2} \qquad [ Equation 8 ]$$

Here, C denotes a coefficient for reflecting a relative consideration degree of first and second sections of a target function. The second section is added to Equation 4 so that similar output values are obtained with respect to similar input values.

W_{m,n} of the second section indicates similarity between m^{th} face image data and n^{th} face image data, and is denoted by Equation 9.

w_{m,n}=exp(−∥xₘ−xₙ∥²/σ²) [Equation 9]

In addition, by reflecting the above, Equation 7 is corrected using Equation 10 so that similar output values are obtained with respect to similar input values while enabling the output value and the target value to coincide.

$$Min . {C}_{1} {\sum }_{n = 1}^{N} ( {ξ}_{n} + {\hat{ξ}}_{n} ) + \frac{{C}_{2}}{2} {‖ a ‖}^{2} + \frac{1}{{N}^{2}} {\sum }_{m = 1}^{N} {\sum }_{n = 1}^{N} {{w}_{m , n} ( y ( {x}_{m} , a ) - y ( {x}_{n} , a ) )}^{2} \qquad [ Equation 10 ]$$

subject to.

tₙ≦y(xₙ,a)+ε+ξₙ, for n=1, . . . , N

tₙ≦y(xₙ,a)−ε−ξₙ, for n=1, . . . , N

Here, C₁ and C₂ denote a coefficient for reflecting a relative consideration degree of first, second, and third sections of a target function. The third section is added to Equation 7 so that similar output values are obtained with respect to the similar input values.

Another configuration example of the learning using the regression analyzer for the detailed age estimation and detailed pose estimation using face information will be described in detail.

In the case of the detailed age estimation or detailed pose estimation using the face information, face image data corresponding to input values of learning data are relatively easily collected, but it is significantly difficult to collect values with respect to detailed ages or detailed poses corresponding to the target value.

When the learning data is insufficient, over-fitting may occur, and therefore it is difficult to expect high recognition performance.

As described in the detailed age or pose estimation, when the number of pieces of the learning data without the target value is large, whereas the learning data having the target value is insufficient, it is preferable that learning of the regression analyzer be performed so that the learning data without the target value has similar output values with respect to similar input values in order to reduce performance deterioration due to over-fitting and improve recognition accuracy.

By reflecting this, Equation 4 is corrected and represented as Equation 11.

$$E ( w ) = \frac{C}{2} {\sum }_{n = 1}^{N} {\{ y ( {x}_{n} , a ) - {t}_{n} \}}^{2} + \frac{1}{{N}^{2}} {\sum }_{m = 1}^{N} {\sum }_{n = 1}^{N} {{w}_{m , n} ( y ( {x}_{m} , a ) - y ( {x}_{n} . a ) )}^{2} \qquad [ Equation 11 ]$$

Here, among N numbered entire learning data, indexes of learning data having target values are represented as 1 to T, and indexes of the learning data without the target values are represented as T+1 to N. In addition, C is a coefficient for reflecting relative consideration information of first and second sections of a target function.

The first section of Equation 11 is corrected so that learning with respect to only the learning data having target values is performed in accordance with the target values. In addition, in the case of data without the target values including data having the target values, the second section is added so that similar output values are obtained with respect to similar input values.

As described above, in the case of the learning data without the target value, Equation 7 is corrected such as in Equation 12 so that similar output values are obtained with respect to similar input values.

$$Min . {C}_{1} {\sum }_{n = 1}^{N} ( {ξ}_{n} + {\hat{ξ}}_{n} ) + \frac{{C}_{2}}{2} {‖ a ‖}^{2} + \frac{1}{{N}^{2}} {\sum }_{m = 1}^{N} {\sum }_{n = 1}^{N} {{w}_{m , n} ( y ( {x}_{m} , a ) - y ( {x}_{n} , a ) )}^{2} \qquad [ Equation 12 ]$$

subject to.

tₙ≦y(xₙ,a)+ε+ξₙ, for n=1, . . . , N

tₙ≦y(xₙ,a)−ε−ξₙ, for n=1, . . . , N

Here, C₁ and C₂ are coefficients for reflecting a relative consideration degree of the first, the second, and the third sections of a target function.

The first section of Equation 12 is corrected so that learning with respect to only the learning data having the target value is performed in accordance with the target value. In addition, in the case of data without the target value including the data having the target value, the third section is added so that similar output values are obtained with respect to similar input values.

Still another configuration of the learning using the regression analyzer for the detailed age estimation or the detailed pose estimation using the face information will be described in detail.

The age of a person may be estimated through a face of the person, but it is not easy to accurately determine the age of the person. In particular, this may mean that the number of overlapping portions of feature regions of face image data included in mutually different two groups is large on a feature space from the point of view of pattern recognition.

Referring to FIG. 13, as in data indicated by an arrow of FIG. 13, technically, it is not easy to distinguish data isolated in a region where data of another group is densely positioned.

For example, technically, it is not easy to infer the age of a person having a baby face such as mid 30s even though the actual age of the person is 40s, using only face image information (or features).

When the isolated data corresponds to noise or outline, and learning of a regression analyzer or a classifier is performed with respect to even the isolated data so that the detailed age is accurately estimated or the ages are divided, recognition performance is reduced due to over-fitting as a whole.

Accordingly, preferably, face image data whose age division is ambiguous may be separately gathered, and used in the learning so as to be induced from a similar relationship of neighboring data (or similar data), rather than performing learning of the regression analyzer or the classifier with respect to the face image data in accordance with the actual age.

When the face image data whose age division is ambiguous is separately gathered and used in the learning so as to be induced from the similar relation of the neighboring data, deterioration of recognition performance due to over-fitting may be prevented, and an age recognizer for outputting a natural recognition result similar to recognition of a human being may be configured.

A method of selecting learning data whose division is ambiguous may be applied to all or a part of steps of data division which have been described in FIG. 3 (or FIG. 2), and the learning data whose division is ambiguous may be selected.

As described in FIG. 3 (or FIG. 2), the features for readily distinguishing two groups are extracted or selected, probability distribution with respect to the features for each group is estimated, and then a posteriori probability may be calculated through the estimated probability distribution.

Referring to FIG. 14, (a) indicates probability distribution (p(x|C₁), p(x|C₂)) with respect to the features for each group, and (b) indicates a posteriori probability (p(C₁|x)), p(C₂|x)) with respect to one dimension features x. Here, probability distribution for each group may be estimated, and a posteriori probability may be calculated from the estimated probability distribution for each group.

Next, data (or data included in a rejection region) whose a posteriori probability is lower than a threshold value (A) is selected as the learning data whose division is ambiguous.

Alternatively, using data features selected as to readily distinguish two groups and learning data included in the corresponding two groups, learning of a regression analyzer for detailed age estimation is performed. Thereafter, data in which the age estimated by the actual age and the regression analyzer is the oldest is selected as the learning data whose division is ambiguous.

Alternatively, using data features selected so as to readily distinguish two groups and learning data included in the corresponding two groups, learning of an analyzer for two groups is performed. Thereafter, data in which groups (output values) estimated by an actual group (target value) and the classifier are different is selected as the learning data whose division is ambiguous.

Alternatively, as shown in (a) of FIG. 15, probability distribution (p(y(x)|C₁), p(y(x)|C₂)) for each group with respect to a classification result (y(x)) with respect to the learning data x is estimated, and as shown in (b) of FIG. 15, a posteriori probability (P(C₁|y(x))), p(C₂|y(x))) is calculated from the estimated probability distribution for each group.

Thereafter, data (or data included in a rejection region) whose a posteriori probability is lower than a threshold value (θ) is selected as the learning data whose division is ambiguous.

Here, Equation 13 is obtained by correcting Equation 4 so that the data whose division is ambiguous is induced from the similar relationship of neighboring data (or similar data) rather than training the regression analyzer in accordance with the actual age.

$$E ( w ) = \frac{C}{2} {\sum }_{n = 1}^{T} {\{ y ( {x}_{n} , a ) - {t}_{n} \}}^{2} + \frac{1}{{N}^{2}} {\sum }_{m = 1}^{N} {\sum }_{n = 1}^{N} {{w}_{m , n} ( y ( {x}_{m} , a ) - y ( {x}_{n} . a ) )}^{2} \qquad [ Equation 13 ]$$

Here, the learning data whose division is ambiguous is represented as indexes of T+1 to N. That is, data whose division is ambiguous, which is selected from N numbered entire learning data, is represented as xₙ, T+1≦n≦N. In addition, C denotes a coefficient for reflecting relative consideration information of the first and second sections of a target function.

The first section is corrected so as to be learned in accordance with the actual age with respect to only data whose division is clear, and in data whose division is ambiguous, the second section is added to Equation 4 so that the age is induced from the similar relationship of neighboring data (or similar data).

W_{m,n} of the second section denotes similarity between m^{th} face image data and n^{th} face image data.

In addition, Equation 14 is obtained by correcting Equation 7 so that the data whose division is ambiguous is induced from a similar relationship of neighboring data (or similar data) rather than training the regression analyzer in accordance with the actual age.

$$Min . {C}_{1} {\sum }_{n = 1}^{N} ( {ξ}_{n} + {\hat{ξ}}_{n} ) + \frac{{C}_{2}}{2} {‖ a ‖}^{2} + \frac{1}{{N}^{2}} {\sum }_{m = 1}^{N} {\sum }_{n = 1}^{N} {{w}_{m , n} ( y ( {x}_{m} , a ) - y ( {x}_{n} , a ) )}^{2} \qquad [ Equation 14 ]$$

subject to.

tₙ≦y(xₙ,a)+ε+ξₙ, for n=1, . . . , N

tₙ≦y(xₙ,a)−ε−ξₙ, for n=1, . . . , N

Here, C₁ and C₂ denote coefficients for reflecting a relative consideration degree of the first, the second, and the third sections of the target function.

The first section is corrected so as to be learned in accordance with the actual age with respect to only data whose division is clear, and the third section is added to Equation 7 so that data whose division is ambiguous is induced from the similar relationship of neighboring data (or similar data).

As described above, in the learning method and learning apparatus using the extracted data features according to embodiments of the present invention, input learning data is divided into two groups in a stepwise manner, and data features for distinguishing the divided groups are extracted, and therefore learning is performed using the extracted data features.

Accordingly, features for readily distinguishing each group by dividing learning data in a stepwise manner are extracted, and therefore the regression analyzer or the multi-classifier may be effectively configured. In addition, when the present invention is utilized in the age recognition or the pose estimation based on the face image data, an analyzer having high recognition performance may be configured.

While the example embodiments of the present invention and their advantages have been described in detail, it should be understood that various changes, substitutions and alterations may be made herein without departing from the scope of the invention.

What is claimed is:

1. A learning method using extracted data features, which is performed in a learning device, comprising:
dividing input learning data into two groups based on a predetermined reference;
extracting data features for distinguishing the two divided groups; and
performing learning using the extracted data features.

2. The learning method of claim 1, after the extracting, further comprising:
dividing, when there is a group required to be divided into sub-groups among the two groups, the group required to be divided into the sub-groups; and
extracting data features for distinguishing the divided sub-groups.

3. The learning method of claim 1, wherein the extracting of the data features for distinguishing the two divided groups includes
setting one group of the two divided groups as a class 1 and setting the other group thereof as a class 2,
acquiring a variance between the class 1 and the class 2 and a projection vector for enabling a ratio of the variance between the class 1 and the class 2 to be a maximum value, and
extracting the data features by projecting the input learning data to the acquired projection vector.

4. The learning method of claim 1, wherein the extracting of the data features for distinguishing the two divided groups includes
extracting candidate features for the input learning data,
assigning a weight to individual data included in the input learning data,
selecting a part of the individual data in accordance with the weight assigned to the individual data,
learning classifiers for classifying the two groups using the part of the individual data with respect to each of the candidate features,
calculating accuracy of the classifiers based on the input learning data and the weight assigned to the individual data,
selecting the classifier having the highest accuracy as the classifier having the highest classification performance, and
extracting the candidate features used in learning the classifier having the highest classification performance as the data features for distinguishing the two groups.

5. The learning method of claim 4, wherein the extracting of the data features for distinguishing the two divided groups further includes
reducing the weight of the individual data classified by the classifier having the highest classification performance, and increasing the weight of the individual data excluding the classified individual data,
determining whether the data features for distinguishing the two groups are output by the number of the data features set in advance, and
repeatedly performing the process from the selecting of the part of the individual data to the determining until the data features for distinguishing the two groups are extracted by the number of the data features set in advance when the data features are determined not to be extracted by the number of the data features set in advance.

6. The learning method of claim 5, wherein, in the selecting of the part of the individual data, a probability of selecting the higher weight assigned to the individual data is high.

7. The learning method of claim 1, wherein the extracting of the data features for distinguishing the two divided groups includes extracting the data features for distinguishing the two divided groups through at least one of an image filter, a texture expression method, wavelet analysis, a Fourier transform, a dimension reduction method, and a feature extraction means.

8. The learning method of claim 1, further comprising, after the performing of the learning:
inputting face image data to a result of the performing of the learning to thereby extract an age or a pose corresponding to the face image data.

9. A learning apparatus using extracted data features, comprising:
a learning data providing unit that provides input learning data;
a feature extraction unit that divides the learning data into two groups based on a predetermined reference, and extracts data features for distinguishing the two divided groups to thereby provide the extracted data features; and
a processing unit that performs learning using the extracted data features.

10. The learning apparatus of claim 9, wherein, when there is a group required to be divided into sub-groups among the two groups, the feature extraction unit divides the group required to be divided into the sub-groups, and extracts data features for distinguishing the divided sub-groups to thereby provide the extracted data features to the processing unit.

11. The learning apparatus of claim 9, wherein the feature extraction unit sets one group of the two divided groups as a class 1 and sets the other group thereof as a class 2, acquires a variance between the class 1 and the class 2 and a projection vector for enabling a ratio of the variance between the class 1 and the class 2 to be a maximum value, and then extracts the data features by projecting the input learning data to the acquired projection vector.

12. The learning apparatus of claim 9, wherein the feature extraction unit extracts the data features for distinguishing the two divided groups through at least one of an image filter, a texture expression method, wavelet analysis, a Fourier transform, a dimension reduction method, and a feature extraction means.

13. The learning apparatus of claim 9, wherein, when face image data is provided from the learning data providing unit, the processing unit inputs the face image data to a result obtained by performing the learning to thereby extract an age or a pose corresponding to the face image data.
